(19) United States
(12) Patent Application Publication
(10) Pub. No.: US 2024/0397849 A1
(43) Pub. Date: Dec. 5, 2024

(54) GREENHOUSE GAS-AWARE EARTHWORM MANAGEMENT FOR SUSTAINABLE AGRICULTURE

(71) Applicant: INTERNATIONAL BUSINESS MACHINES CORPORATION, ARMONK, NY (US)

(72) Inventors: Jagabondhu Hazra, HBR Layout 5 (IN); Manikandan Padmanaban, Chennai (IN); Sarbajit K. Rakshit, Kolkata (IN)

(21) Appl. No.: 18/327,246

(22) Filed: Jun. 1, 2023

(51) Int. Cl. A01B 79/00; G05B 15/00; G06Q 50/02

(52) U.S. Cl. CPC A01B 79/005; G05B 15/00; G06Q 50/02; G05B 2219/2625

(57) ABSTRACT

According to one embodiment, a method, computer system, and computer program product for agricultural earthworm management is provided. The present invention may include identifying a crop type and a growth stage associated with a plant cultivated within an agricultural sector; estimating a nutrient requirement and a water requirement associated with the plant based on the crop type and the growth stage; determining a desired soil moisture value for the agricultural sector based on the nutrient requirement, the water requirement, an earthworm productivity, a soil moisture and a soil temperature; and operating an irrigation system to adjust the soil moisture of the agricultural sector to match the desired soil moisture value.

### BACKGROUND

The present invention relates, generally, to the field of computing, and more particularly to smart farming.

The field of smart farming, also known as precision agriculture or digital farming, is an advanced approach to agricultural management that leverages technology and data analytics to optimize the efficiency, productivity, and sustainability of agricultural practices. It combines various technologies such as sensors, Internet of Things (IoT) devices, aerial vehicles, satellite imagery, and artificial intelligence (AI) to collect and analyze data on crop growth, soil conditions, weather patterns, and other relevant factors.

The key objective of smart farming is to enable farmers to make more informed decisions and take precise actions based on real-time data and insights. By using technology-driven solutions, farmers can monitor and control various aspects of their agricultural operations more efficiently, reducing resource wastage, minimizing environmental impact, and improving overall productivity.

### SUMMARY

According to one embodiment, a method, computer system, and computer program product for agricultural earthworm management is provided. The present invention may include identifying a crop type and a growth stage associated with a plant cultivated within an agricultural sector; estimating a nutrient requirement and a water requirement associated with the plant based on the crop type and the growth stage; determining a desired soil moisture value for the agricultural sector based on the nutrient requirement, the water requirement, an earthworm productivity, a soil moisture and a soil temperature; and operating an irrigation system to adjust the soil moisture of the agricultural sector to match the desired soil moisture value.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment; and

FIG. 2 is an operational flowchart illustrating an earthworm management process according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate to the field of computing, and more particularly to smart farming. The following described exemplary embodiments provide a system, method, and program product for, among other things, controlling soil moisture and temperature within an agricultural sector to minimize greenhouse gas emissions from earthworm activity while maintaining the health of the earthworms and the availability of plant nutrients in the agricultural sector.

As previously described, the field of smart farming, also known as precision agriculture or digital farming, is an advanced approach to agricultural management that leverages technology and data analytics to optimize the efficiency, productivity, and sustainability of agricultural practices. One crucial but oftentimes overlooked aspect of agricultural management is that of earthworm activity; earthworm presence in agroecosystems lead to significant increases in crop yield and aboveground biomass. Earthworms can produce hundreds of pounds of casts every day per acre of soil. Earthworms subsist on a diet including leaf litter, soil organic matter, plant residues, and mineral particles; in the gut of the earthworm, these materials are broken down into mineral nitrogen and carbon. Enrichment of mineral nitrogen and carbon, in concert with favorable moisture levels, stimulate denitrifier activity by bacteria resulting in the production of atmospheric nitrogen N2O. The earthworm may excrete plant nutrients and atmospheric nitrogen through the nephridia and may exhale carbon dioxide through its skin as a byproduct of respiration. Both CO2 and N2O are considered to be greenhouse gases, which are gases that, when in the atmosphere, trap heat and contribute to the greenhouse effect, contributing to the warming of the planet. As a result, earthworm presence increases both plant nutrients in the soil as well as greenhouse gas emissions by significant amounts.

At different temperatures, different moisture levels in the soil influence cast production in earthworms; in some cases, earthworm cast production has a positive co-relation with soil moisture for a given temperature. In other cases, earthworm cast production has a negative co-relation with soil temperature for a given soil moisture. Earthworm casts comprise finely processed soil that provide essential nutrients for plants; as such, cast production directly correlates with plant nutrients added to the soil. When soil becomes too hot or dry, earthworms become inactive and undergo a process called aestivation, wherein the earthworm moves deeper into the soil and lowers its metabolic rate in order to reduce water loss. The earthworm will remain dormant until conditions become favorable; namely, until heat levels decrease and/or moisture levels increase. While dormant, earthworms' cast production and greenhouse gas emissions are greatly reduced.

During different stages of growth, plants absorb nutrients from the soil at varying rates. The rate of growth and nutrient demand over time for each different genus of plant may be described by a growth profile. For example, corn crops may grow slowly and require relatively low amounts of soil nutrients until a vegetative growth stage of approximately one month in duration, at which point the corn's nutrient demand rises precipitously as the corn rapidly grows and matures before slowing again as the plant approaches full maturity. Providing sufficient nutrients to the plant for the duration of its life cycle is crucial for maintaining the plant's health and productive yield. As such, it may be advantageous to, among other things, implement a system that controls the moisture level of an agricultural sector to increase or decrease earthworm activity, thereby increasing or decreasing available soil nutrients to match a growth profile of a crop, while decreasing worm activity when soil nutrients are not needed to reduce greenhouse gas emissions and thereby decrease the contribution of farming operations to the greenhouse effect and the global climate. Therefore, the present embodiment has the capacity to improve the technical field of smart farming by increasing the productivity of a crop while reducing greenhouse gas emissions and making farming more sustainable.

According to one embodiment, the invention is a system and method of using a combination of remotely sensed satellite data, weather data, earthworm distribution, and the growth profile of a crop to determine a desired soil moisture value that maximizes crop productivity while minimizing greenhouse gas emissions; and operating an irrigation system to adjust the actual soil moisture to match the desired soil moisture value.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

The following described exemplary embodiments provide a system, method, and program product for controlling soil moisture and temperature within an agricultural sector to minimize greenhouse gas emissions from earthworm activity while maintaining the health of the earthworms and the availability of plant nutrients in the agricultural sector.

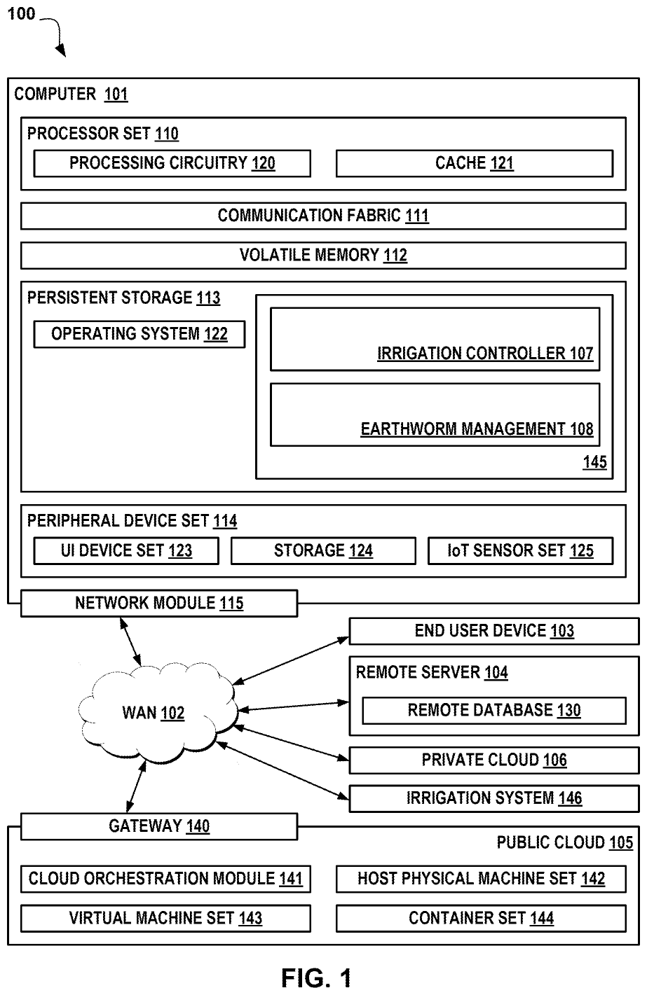

Referring now to FIG. 1, computing environment 100 contains an example of an environment for the execution of at least some of the computer code involved in performing the inventive methods, such as code block 145, which may comprise irrigation controller program 107 and earthworm management program 108. In addition to code block 145, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and code block 145, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in code block 145 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in code block 145 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, sensors may include soil moisture sensors, optical or infrared cameras, soil temperature sensors, soil chemical composition sensors, et cetera.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

According to the present embodiment, the irrigation controller 107 may be a program capable of operating and/or controlling an irrigation system 146 which distributes water to an agricultural sector, thereby increasing the soil moisture. The irrigation system 146 may comprise any number or combination of pipes, sprinklers, nozzles, water tanks, pumps, misters, drip irrigators, rotationally or laterally motive arms, hoses, vehicles, or other hardware elements, that together comprise a comprehensive network capable of delivering water to crops within an agricultural sector. The irrigation system 146 may comprise, for example, a center pivot irrigation system, lateral move irrigation system, sub-irrigation system, drip irrigation system, sprinkler irrigation system, et cetera. In embodiments of the invention, the irrigation controller 107 may be a subroutine, module, function, or any other subcomponent of earthworm management program 108, and/or may be configured to communicate and/or interoperate with earthworm management program 108.

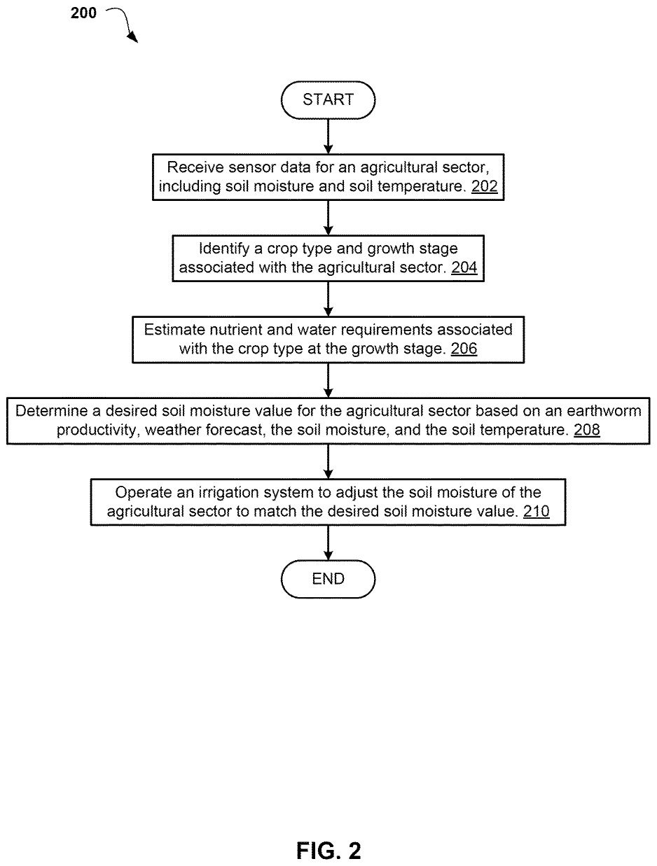

According to the present embodiment, the earthworm management program 108 may be a program capable of controlling soil moisture and temperature within an agricultural sector to minimize greenhouse gas emissions from earthworm activity while maintaining the health of the earthworms and the availability of plant nutrients in the agricultural sector. The earthworm management program 108 may, when executed, cause the computing environment 100 to carry out an earthworm management process 200. The earthworm management process 200 may be explained in further detail below with respect to FIG. 2. In embodiments of the invention, the earthworm management program 108 may be stored and/or run within or by any number or combination of devices including computer 101, end user device 103, remote server 104, private cloud 106, and/or public cloud 105, peripheral device set 114, and server 112 and/or on any other device connected to WAN 102. Furthermore, earthworm management program 108 may be distributed in its operation over any number or combination of the aforementioned devices. In embodiments of the invention, the earthworm management program 108 may comprise, communicate with, control, and/or interoperate with irrigation controller 107.

Referring now to FIG. 2, an operational flowchart illustrating an earthworm management process 200 is depicted according to at least one embodiment. At 202, the earthworm management program 108 may receive sensor data for an agricultural sector, including soil moisture and soil temperature. Here, earthworm management program 108 may receive sensor data from sensors deployed within and/or gathering data regarding the agricultural sector. The agricultural sector may be a single contiguous region of land within which a single uniform type of plant or crop is cultivated, and which may be provided controlled amounts of water by an irrigation system such that the soil moisture of the agricultural sector may be adjusted. One or more sensors may be disposed within or geographically proximate to the agricultural sector, such that the sensors are measuring prevailing environmental conditions of the agricultural sector. At least one of the sensors may be a soil temperature sensor, which may measure the temperature of the soil within the agricultural sector. At least one of the sensors may be a soil moisture sensor, which measures the moisture level of the soil within the agricultural sector. The soil moisture sensor may measure soil moisture of the topsoil, for example to a depth of 5-10 inches. In embodiments, multiple soil temperature and/or soil moisture sensors may be distributed at uniform intervals across the agricultural sector to provide a more granular assessment of the soil moisture and soil temperature of the agricultural sector.

In embodiments, the sensors may further comprise atmospheric temperature sensors, barometric pressure sensors, soil chemistry sensors, infrared and/or visible spectrum cameras, rainfall collectors, wind sensors, et cetera. In some embodiments of the invention, sensor data may comprise satellite and/or other aerial imagery of the agricultural sector. The earthworm management program 108 may monitor readings from such sensors in real time and/or at regular intervals, for example on the order of minutes or hours.

At 204, the earthworm management program 108 may identify a crop type and growth stage associated with the agricultural sector. Here, the earthworm management program 108 may identify which crop is being cultivated in the agricultural sector, and what stage of growth that crop has reached. The earthworm management program 108 may be pre-provided with a corpus of plant data, which may comprise a number of likely types of plants that may be cultivated for agricultural purposes, as well as visual identification data such as sample images and/or visual descriptions associated with such plant types at different stages of the plant's growth, from seedling to mature adult. In embodiments, the plant data may further comprise a growth profile, which may describe the stages of a plant's development in terms of the typical duration spent at each growth stage and the typical water and nutrient requirements of the plant at each growth stage. In some embodiments, the earthworm management program 108 may be pre-provided the type of plant that is being cultivated in the agricultural sector. In some embodiments, for example where the sensors comprise infrared or visible spectrum cameras and/or the sensor data comprises satellite or aerial imagery, the earthworm management program 108 may analyze visual or infrared imagery using image processing techniques to extract the visual characteristics of the plant type present in the agricultural sector, and identify the plant type and/or stage of growth by matching such visual characteristics against a description and/or sample images in the plant data. Once identified, the plant type may be saved in association with the agricultural sector in which it is present, such that it need not be identified again until the plants have been harvested. In embodiments, the stage of growth may be identified at regular intervals, for example every day, every other day, every week, et cetera. In some embodiments, for example where visual or infrared imagery is unavailable, the earthworm management program 108 may receive information on the stage of plant growth from an external source, such as a human user.

At 206, the earthworm management program 108 may estimate nutrient and water requirements associated with the crop type at the growth stage. Here, the earthworm management program 108 may consult the growth profile of the plant data associated with the plant cultivated in the agricultural sector to determine the typical nutrient and water requirements of the plant at its current growth stage. The earthworm management program 108 may adjust these typical values based on the actual water and nutrients available to the plant, to determine nutrient and water requirements that are in excess of what is already provided to the plants. For example, the earthworm management program 108 may determine actual nutrients available to the plant based on chemical soil composition sensor data, external data regarding types of fertilization applied to the agricultural sector and/or past crops grown in the agricultural sector and/or whether the agricultural sector was left fallow, et cetera. Likewise, the earthworm management program 108 may determine actual water available to the plant based on rainfall data, soil moisture, humidity, past precipitation, et cetera.

At 208, the earthworm management program 108 may determine a desired soil moisture value for the agricultural sector based on an earthworm productivity, weather forecast, the soil moisture, and the soil temperature. Here, the earthworm management program 108 may infer an earthworm productivity based on pre-provided earthworm data regarding earthworm density, cast production numbers at different soil temperatures and moisture levels, and the nutrients added to the soil by the cast, wherein earthworm productivity may be the amount of nutrients added to the soil for a given temperature and moisture value. Earthworm density may indicate a number of earthworms per volume of soil. The earthworm management program 108 may therefore infer, based on the current soil temperature and the productivity of the earthworms, the moisture level necessary to stimulate earthworms in the agricultural sector to produce sufficient soil nutrients to meet the nutritional need of the cultivated plants. This inferred moisture level, adjusted to additionally meet any water requirement of the plants, represents the desired soil moisture value. The desired soil moisture value may additionally be modified to account for any predicted increase in the moisture level that may originate from sources external to the irrigation system; for example, predicted increases to the moisture level that may occur from forecast precipitation, humidity, flooding, et cetera. In embodiments, the earthworm management program 108 may determine a minimum and a maximum desired soil moisture value based on the minimum and maximum soil moisture levels that an earthworm can survive and may ensure that the desired soil moisture value falls within the range described by the minimum and maximum values.

In some embodiments, for example where the nutrient and water requirements are met or exceeded, and/or the plants are in a growth stage with low nutrient and/or water requirements, the earthworm management program 108 may induce aestivation in the earthworm population of the agricultural sector by setting the desired soil moisture value to a level at or below the moisture level at which earthworms enter aestivation based on the soil temperature, therefore minimizing greenhouse gas production from the earthworms. The earthworm management program 108 may extrapolate a future nutrient requirement based on the plant's growth profile and current growth stage, and may modify the desired soil moisture value to bring the earthworms out of aestivation such that the earthworms, once awoken, have sufficient time and moisture to produce a sufficient quantity of soil nutrients ahead of time to meet the predicted future nutrient requirement, such that the soil nutrients are available at the time the plant needs them, for example when entering a stage of accelerated vegetative growth.

In embodiments, the desired soil moisture value may be calculated at regular intervals, for example every hour, every day, every day and a half, et cetera; in embodiments, the desired soil moisture value may additionally or alternatively be calculated in response to one or more events such as predicted or experienced precipitation or humidity, changes in temperature exceeding a threshold magnitude, a determination that the plants are entering a new stage of growth, a change in sensor readings exceeding a threshold magnitude, et cetera.

In an exemplary embodiment, given an N grid of spatially distributed changes in soil moisture, the earthworm management program 108 may select a desired soil moisture value that reduces the overall greenhouse gas emissions by controlling soil moisture without compromising on crop water stress, nutrient requirements, earthworm's survival soil moisture, and temperature. The desired soil moisture value may therefore be described by the following equation:

$$J = Min . {\sum }_{{j = 1}_{t}}^{N} \{ G H {G ( S {M}_{jt} , Tjt )}_{j , t}$$

Where the crop nutrient requirements constraint is described as follows:

$$Cast {( S {M}_{it} , Tjt )}_{j , t} \geq {C\_Nutrients}_{j , t}$$

Where the crop water stress constraint is described as follows:

$${C\_water}_{min , j , t} \geq {C}_{{water}_{j , t}} ( S M jt ) \leq {C\_water}_{max , j , t}$$

Where the earthworm's survival constraints are described by the following equation:

$$S {M}_{min , j , t} \geq S {M}_{j , t} \leq S {M}_{max , j , t} ; {T}_{min , j , t} \geq {T ( S {M}_{i} )}_{j , t} \leq {T}_{max , j , t}$$

### Wherein:

J represents the cost function;
GHG(SM,T)_{j,t} represents the total greenhouse gas emissions computed using process-based model (DNDC), which is a function of soil moisture (SM) and soil temperature (T) at pixel ‘j’ for time ‘t’;
Cast(SM,T)_{j,t} represents earthworm cast production for pixel ‘j’ at time ‘t’;
C_Nutrients_{j,t} represents crop nutrient requirements for at pixel ‘j’ at time ‘t’;
C_{water j,t} represents crop water requirements at pixel ‘j’ for a time ‘t’;
SM_{min,j,t}, SM_{max,j,t} represents minimum and maximum soil moisture that an earthworm may survive; and wherein
T_{min,j,t}, T_{max,j,t} represents minimum and maximum temperatures that the earthworms may survive.

In another exemplary embodiment, at each step, the earthworm management program 108 should choose a desired soil moisture value that it is optimal for next ‘K’ steps, considering the sudden change in the soil moisture is practically infeasible (like sudden decrease in soil moisture). The control of soil moisture must be very precise and should subject to small step change while taking the whole prediction horizon into account. As such, the desired soil moisture value may be described by the following equation:

$$J = {{\sum }_{i = 1}}^{N} {{w}_{{H}_{i}} ( {H}_{i}^{r} - {H}_{i}^{m} )}^{2} + {{\sum }_{i = 1}}^{N} {{w}_{{uH}_{i}} ( Δ u )}^{2}$$

$${H}^{min} \leq {H}_{i}^{m} \leq {H}^{max}$$

### Subject to

### Wherein:

J represents a cost function over the receding horizon;
Hᵢ^{r} represents a required optimal soil moisture for the instant ‘i’;
Hᵢ^{m} represents a measured soil moisture for the instant ‘i’;
u represents a soil moisture variable;
W_{H}_{ᵢ} represents a weighting coefficient for soil moisture;
W_{uH}_{ᵢ}, W_{uL}_{ᵢ} represents a penalizing coefficient for big changes in soil moisture controller, respectively; and wherein
H^{min}, H^{max} represents a minimum and maximum limit for soil moisture, respectively.

At 210, the earthworm management program 108 may operate an irrigation system to adjust the soil moisture of the agricultural sector to match the desired soil moisture value. Here, the earthworm management program 108 may check the desired soil moisture value against the actual soil moisture recorded by sensors; if the desired soil moisture value exceeds the actual soil moisture, the earthworm management program 108 may order, operate, or otherwise cause irrigation controller 107 to administer an amount of water to the agricultural sector sufficient to increase the soil moisture of the agricultural sector to match the desired soil moisture value. If the desired soil moisture value falls below the actual soil moisture, the earthworm management program 108 may bar irrigation controller 107 from providing water until the desired soil moisture value has been reached.

It may be appreciated that FIG. 2 provides only an illustration of one implementation and does not imply any limitations with regard to how different embodiments may be implemented. Many modifications to the depicted environments may be made based on design and implementation requirements.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method for agricultural earthworm management, the method comprising:
identifying a crop type and a growth stage associated with a plant cultivated within an agricultural sector;
estimating a nutrient requirement and a water requirement associated with the plant based on the crop type and the growth stage; and
determining a desired soil moisture value for the agricultural sector based on the nutrient requirement, the water requirement, an earthworm productivity, and a soil moisture and a soil temperature.

2. The method of claim 1, further comprising: operating an irrigation system to adjust the soil moisture of the agricultural sector to match the desired soil moisture value.

3. The method of claim 1, wherein the desired soil moisture value is a soil moisture level at which earthworms within the agricultural sector will be stimulated to produce soil nutrients sufficient to meet the nutrient requirement based on the soil temperature.

4. The method of claim 1, wherein the desired soil moisture value falls within a range bounded by the minimum and maximum soil moisture levels at which an earthworm can survive.

5. The method of claim 1, responsive to determining that the nutrient requirement and water requirement are met or exceeded, adjusting the desired soil moisture value to induce aestivation in earthworms within the agricultural sector.

6. The method of claim 5, responsive to predicting a future nutrient requirement, adjusting the desired soil moisture value to bring the earthworms in the agricultural sector out of aestivation.

7. The method of claim 1, wherein the identifying is based on an analysis of satellite imagery.

8. A computer system for agricultural earthworm management, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
identifying a crop type and a growth stage associated with a plant cultivated within an agricultural sector;
estimating a nutrient requirement and a water requirement associated with the plant based on the crop type and the growth stage; and
determining a desired soil moisture value for the agricultural sector based on the nutrient requirement, the water requirement, an earthworm productivity, and a soil moisture and a soil temperature.

9. The computer system of claim 8, further comprising: operating an irrigation system to adjust the soil moisture of the agricultural sector to match the desired soil moisture value.

10. The computer system of claim 8, wherein the desired soil moisture value is a soil moisture level at which earthworms within the agricultural sector will be stimulated to produce soil nutrients sufficient to meet the nutrient requirement based on the soil temperature.

11. The computer system of claim 8, wherein the desired soil moisture value falls within a range bounded by the minimum and maximum soil moisture levels at which an earthworm can survive.

12. The computer system of claim 8, responsive to determining that the nutrient requirement and water requirement are met or exceeded, adjusting the desired soil moisture value to induce aestivation in earthworms within the agricultural sector.

13. The computer system of claim 12, responsive to predicting a future nutrient requirement, adjusting the desired soil moisture value to bring the earthworms in the agricultural sector out of aestivation.

14. The computer system of claim 8, wherein the identifying is based on an analysis of satellite imagery.

15. A computer program product for agricultural earthworm management, the computer program product comprising:
one or more computer-readable tangible storage medium and program instructions stored on at least one of the one or more tangible storage medium, the program instructions executable by a processor to cause the processor to perform a method comprising:
identifying a crop type and a growth stage associated with a plant cultivated within an agricultural sector;
estimating a nutrient requirement and a water requirement associated with the plant based on the crop type and the growth stage; and
determining a desired soil moisture value for the agricultural sector based on the nutrient requirement, the water requirement, an earthworm productivity, and a soil moisture and a soil temperature.

16. The computer program product of claim 15, further comprising: operating an irrigation system to adjust the soil moisture of the agricultural sector to match the desired soil moisture value.

17. The computer program product of claim 15, wherein the desired soil moisture value is a soil moisture level at which earthworms within the agricultural sector will be stimulated to produce soil nutrients sufficient to meet the nutrient requirement based on the soil temperature.

18. The computer program product of claim 15, wherein the desired soil moisture value falls within a range bounded by the minimum and maximum soil moisture levels at which an earthworm can survive.

19. The computer program product of claim 15, responsive to determining that the nutrient requirement and water requirement are met or exceeded, adjusting the desired soil moisture value to induce aestivation in earthworms within the agricultural sector.

20. The computer program product of claim 19, responsive to predicting a future nutrient requirement, adjusting the desired soil moisture value to bring the earthworms in the agricultural sector out of aestivation.
